(19) United States
(12) Patent Application Publication
(10) Pub. No.: US 2006/0175822 A1
(43) Pub. Date: Aug. 10, 2006

(54) Engaging structure of loose-leaf storing box

(76) Inventor: Sheng-Yuan Chen, Taipei City (TW)

Correspondence Address: BACON & THOMAS, PLLC, 625 SLATERS LANE, FOURTH FLOOR, ALEXANDRIA, VA, 22314, US

(21) Appl. No.: 11/052,816

(22) Filed: Feb. 9, 2005

(51) Int. Cl. B42D 1/00

(52) U.S. Cl. 281/21.1

(57) ABSTRACT

An engaging structure of a loose-leaf storing box, the storing box is composed mainly of an upper and a lower cover, a connecting sheet is provided between the upper and the lower covers; the engaging structure is characterized in that: the connecting sheet is provided in the receiving space provided by the upper and the lower covers at least with a set of slipping-in member for slipping of a plurality of slipping-over portions of the loose-leaf bags thereover, thereby holes provided on the slipping-over portions can be slipped over the slipping-in member, and an effect of collecting the loose-leaf bags can be obtained.

### BACKGROUND OF THE INVENTION

1. Field of the Invention

The present invention is related to designing of a storing box, and especially to a storing box for storing precious thin articles that are subjected to losing and need preservation such as CDs, photos, memory cards etc.

2. Description of the Prior Art

Generally, in addition to being stored in CD boxes in the most general way, AV CDs can be stored by means of loose-leaf bags, the bags are collected in a loose-leaf box; thus the AV CDs can be well stored.

As shown in FIG. 1, a conventional storing box 10 for storing loose-leaf bags is depicted, the storing box 10 includes an upper plate 11 and a lower plate 12; the upper plate 11 and the lower plate 12 are provided therebetween with a clamp 20 made of stainless steel, the clamp 20 is provided on each of two ends of it with a pressing portion 21, pairs of closed intermediate clamping strips 22 can be opened by means of the pressing portions 21 to place in loose-leaf bags 30.

However, in using such an opening way, the pressing portions 21 on the two ends must be pressed to open the clamping strips 22, and are closed after the loose-leaf bags 30 are placed in; and the pressing portions 21 can only be opened by using a relatively large force, this induces inconvenience in use. And more, the clamp 20 can only be assembled with the storing box 10 after it is produced separately; its cost of production is relatively high.

Therefore, some manufacturer made improvement on the clamp of the above mentioned storing box 10, such as is shown in FIG. 2, mainly it used two mutually opposite protrusions 40 each in the shape of “L” in lieu of the clamp, the two “L” shaped protrusions 40 are provided therebetween with an oblique gap 41, so that holes provided on a plurality of loose-leaf bags can be slipped over the protrusions 40, and an object of storing can thus be obtained.

Such a structure can make the clamp shown in FIG. 1 save more cost, however when in use, the loose-leaf bags must be extended through the oblique gap 41 in the first place, then the holes can be slipped over the protrusions 40; however, by the fact that the width of the oblique gap 41 is relatively smaller, a hole of a loose-leaf bag must be slipped over a protrusion 40, then the other hole is slipped over the other protrusion 40, and the holes must be slipped over one by one; this is quite inconvenient in use.

There appeared another kind of structure of storing box in the markets, such as is shown in FIG. 3, a storing box 10 is provided mainly with an engaging rod 50 in the shape of “U”, one end of the engaging rod 50 is connected with the storing box 10, the other end is a movable end 51; the storing box 10 is provided at a position in opposition to the movable end 51 with a hole 52, thereby loose-leaf bags can be passed through the hole 52 to have holes thereon slipped over the engaging rod 50 to obtain an object of storing.

Such a structure tends to make the holes of the loose-leaf bags slide down to the bottom of the movable end 51 by opening of the storing box 10 to induce dropping of the loose-leaf bags. Moreover, when the loose-leaf bags at the innermost side are to be drawn out for changing, all the outer loose-leaf bags must be removed, and changing of the loose-leaf bags can then be effected; this makes trouble in use by a user.

### SUMMARY OF THE INVENTION

In view of the above problems in storing loose-leaf bags, the inventor of the present invention provides an engaging structure of a loose-leaf storing box based on his professional experience of years in studying, designing and manufacturing same kind of products and after hard study, developing.

The engaging structure of the loose-leaf storing box mainly is composed of an upper and a lower cover, a connecting sheet is provided between the upper and the lower covers; the engaging structure is characterized in that: the connecting sheet is provided in the receiving space provided by the upper and the lower covers at least with a set of slipping-in member for slipping of a plurality of slipping-over portions of the loose-leaf bags thereover, thereby holes provided on the slipping-over portions can be slipped over the slipping-in member, and an effect of collecting the loose-leaf bags can be obtained.

The object of the present invention is: with the engaging structure, the holes on the loose-leaf bags can be fast slipped over the slipping-in member for placing the loose-leaf bags in the loose-leaf storing box to store articles that are subjected to losing and need preservation such as CDs, photos, memory cards etc.

Another object of the present invention is: the slipping-in member is extended out of the connecting sheet and is integrally injection formed together with the storing box using plastic, so that the cost of production can be reduced.

The present invention will be apparent in its content and its effect to be achieved after reading the detailed description of the preferred embodiment thereof in reference to the accompanying drawings.

### BRIEF DESCRIPTION OF THE DRAWINGS

FIG. 1 is a perspective schematic view showing a conventional storing box receiving therein loose-leaf bags;

FIG. 2 is a partially enlarged perspective schematic view showing another storing box not yet receiving therein loose-leaf bags;

FIG. 3 is a sectional schematic view showing another storing box not yet receiving therein loose-leaf bags;

FIG. 4 is a perspective view showing a storing box of the present invention not yet receiving therein loose-leaf bags;

FIG. 5 is a schematic side view showing a first embodiment of a slipping-in member of the present invention;

FIG. 6 is a partially enlarged schematic side view showing the first embodiment of the present invention;

FIG. 7 is a partially enlarged schematic side view showing the first embodiment of the present invention with a loose-leaf bag placing therein;

FIG. 8 is a partially enlarged schematic side view showing a second embodiment of the slipping-in member of the present invention;

FIG. 9 is a partially enlarged schematic side view showing the second embodiment of the present invention with a loose-leaf bag placing therein;

FIG. 10 is a partially enlarged schematic side view showing a third embodiment of the slipping-in member of the present invention.

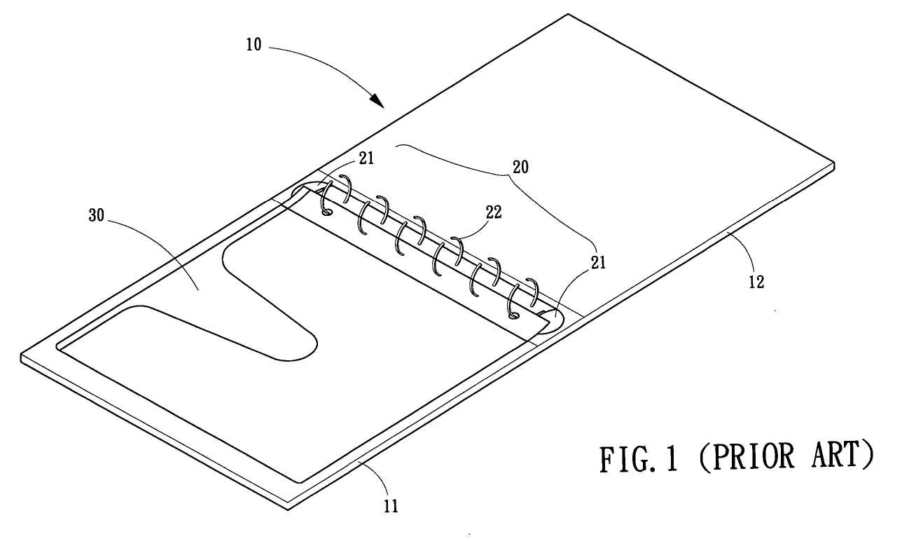

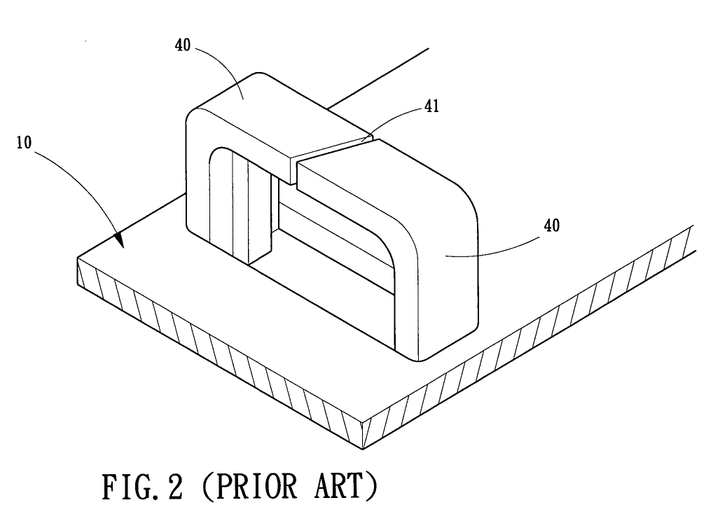

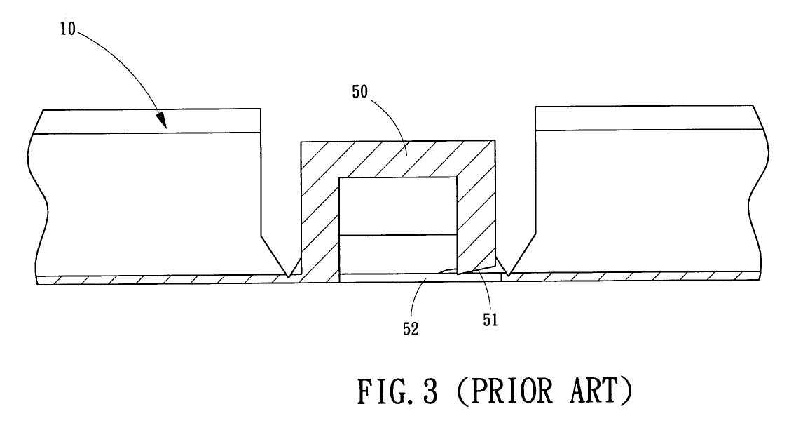

### DETAILED DESCRIPTION OF THE PREFERRED EMBODIMENT

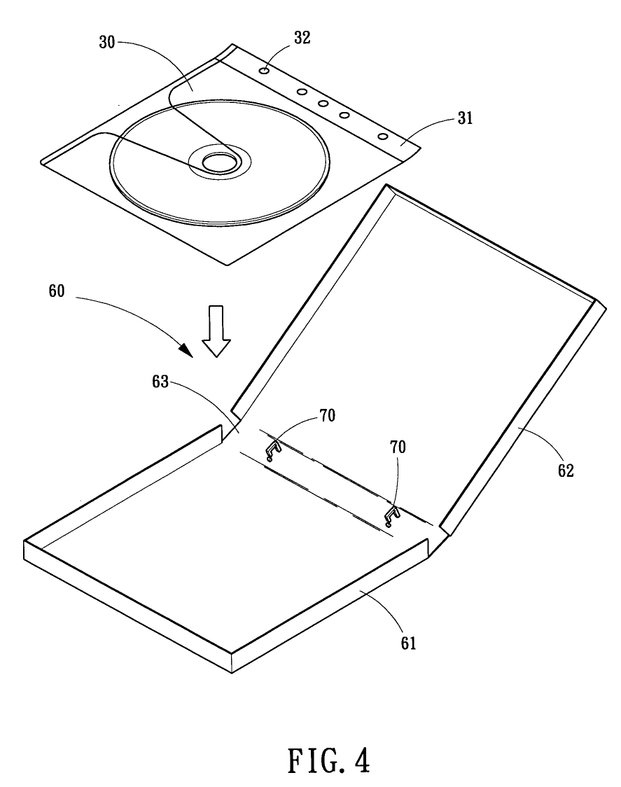

Referring firstly to FIG. 4, in the engaging structure of the loose-leaf storing box of the present invention, a storing box 60 mainly is composed of an upper cover 61 and a lower cover 62, a connecting sheet 63 is provided between the upper and the lower covers 61, 62; when the upper and the lower covers 61, 62 are closed to each other, the connecting sheet 63 exactly function as a side plate of a receiving space that can be used for storing a plurality of loose-leaf bags 30.

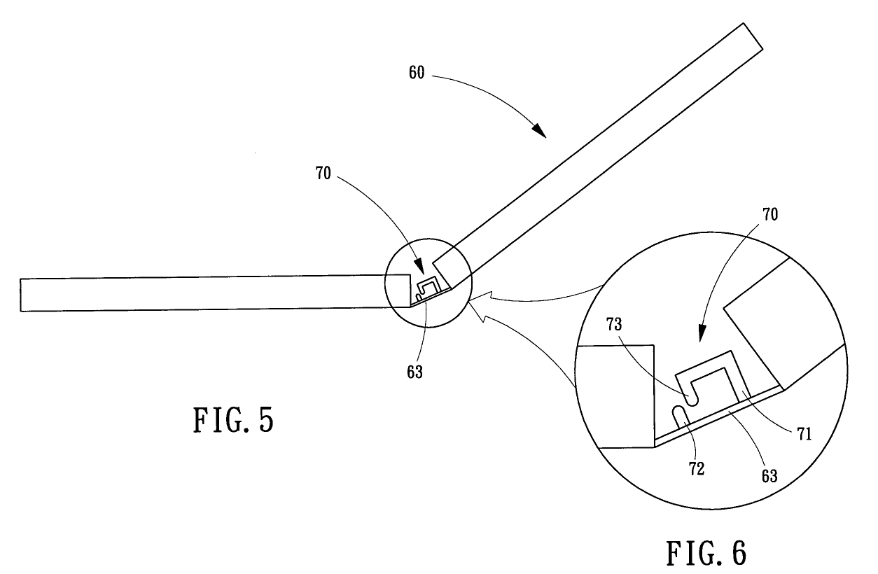

As shown in FIGS. 5 and 6, the connecting sheet 63 is further provided at the interior of the receiving space with at least a set of slipping-in member 70; the slipping-in member 70 includes an engaging rod 71 in the shape of “L” and a stub 72, the engaging rod 71 and the stub 72 of the slipping-in member 70 are extended out of the connecting sheet 63 and are integrally injection formed together with the storing box using plastic, so that the cost of production can be reduced.

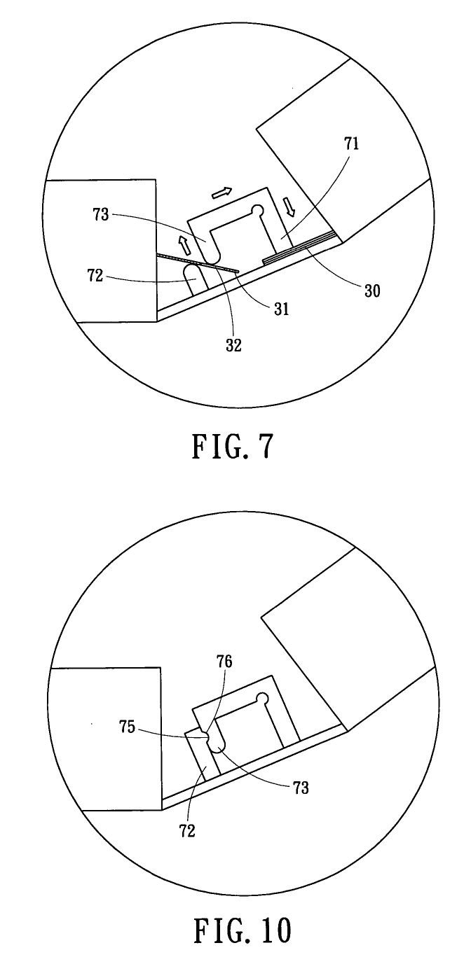

One end of the engaging rod 71 is fixed on the connecting sheet 63, while the other end is an engaging end 73 extending to the stub 72, the engaging end 73 and the stub 72 have therebetween an appropriate gap; the sectional area of either of the engaging rod 71 and the stub 72 is smaller than that of a hole 32 on a slipping-over portion 31 on an edge of any loose-leaf bag 30; as shown in FIG. 7, a loose-leaf bag 30 is extended through the gap between the engaging end 73 and the stub 72 by means of its slipping-over portion 31, then a hole 32 is aligned with the engaging end 73, the hole 32 is slipped over the engaging end 73 and the engaging rod 71 in the shape of “L” sequentially, and the loose-leaf bag 30 is accommodated in the receiving space, and an effect of accommodating and preserving the loose-leaf bag can be obtained; thereby the loose-leaf bags can store thin articles such as CDs, photos, memory cards etc. that are precious and are subjected to losing and need preservation.

As shown in FIGS. 8 and 9, wherein the folded corner of the engaging rod 71 in the shape of “L” further is provided with a resilient section 74, and the engaging rod 71 is endued with elasticity, the stub 72 is able to further extend upwards to tightly abut against the outer side of the engaging end 73; when the engaging end 73 tightly abuts against the stub 72, the engaging rod 71 and the stub 72 are closed relative to each other.

When in storing loose-leaf bags 30, the engaging rod 71 is raised to separate the engaging end 73 from the stub 72; at this time, the engaging rod 71 bears the action force of the resilient section 74 to bend upwards, the engaging end 73 and the stub 72 have an opening therebetween, so that the loose-leaf bags 30 can pass through the hole 32 to be slipped over the engaging end 73, and can be diverted to be slipped over the engaging rod 71, and accommodating of the loose-leaf bags 30 can be achieved.

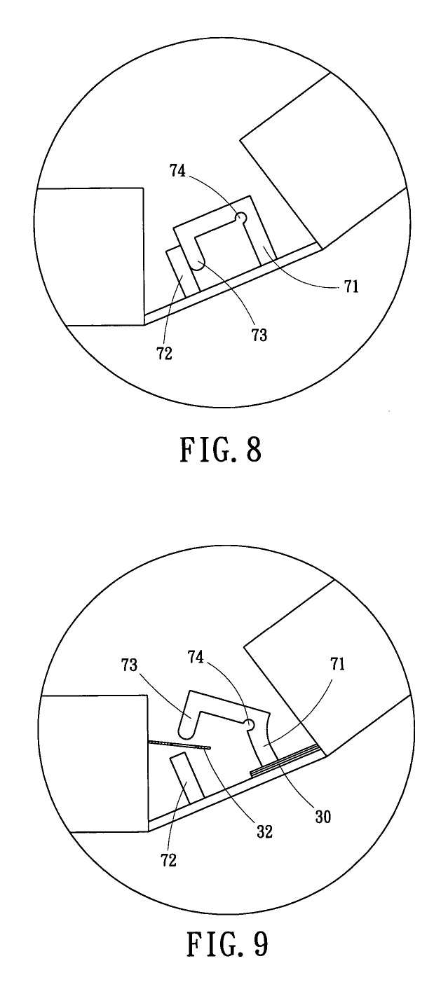

As shown in FIG. 10, the stub 72 and the engaging end 73 are respectively provided at the abutting area between them with an engaging protrusion 75 and an engaging recess 76, by protruding and denting respectively of the engaging protrusion 75 and the engaging recess 76, the engaging end 73 and the stub 72 can be engaged with each other to prevent inadvertent separating of the engaging end 73 from the stub 72 that may induce dropping of the loose-leaf bags 30.

The names of the members composing the present invention are only for illustrating the present invention, and not for giving any limitation to the scope of the present invention. It will be apparent to those skilled in this art that various equivalent modifications or changes without departing from the spirit of this invention shall also fall within the scope of the appended claims.

1. An engaging structure of a loose-leaf storing box, said storing box includes an upper and a lower cover, a connecting sheet is provided between said upper and said lower covers;
when said upper and said lower covers are closed to each other, said connecting sheet exactly function as a side plate of a receiving space that is used for storing a plurality of loose-leaf bags, said engaging structure is characterized in that: said connecting sheet is provided at least with a set of slipping-in member, said slipping-in member includes an engaging rod in a shape of “L” and a stub, one end of said engaging rod is fixed on said connecting sheet, while the other end of said engaging rod is an engaging end extending downwards, said stub is provided outside of said engaging end in order that said loose-leaf bags are adapted to extending in between and over said engaging end and said stub, then a hole on each of said loose-leaf bags is aligned with said engaging end, said hole then is slipped over said engaging rod.

2. The engaging structure of a loose-leaf storing box as in claim 1, wherein: a gap is formed between said engaging end and said stub.

3. The engaging structure of a loose-leaf storing box as in claim 1, wherein: said stub is adapted to extending upwards to tightly abut against an outer side of said engaging end.

4. The engaging structure of a loose-leaf storing box as in claim 3, wherein: said stub is provided with an engaging protrusion, and said engaging end is provided with an engaging recess, said engaging protrusion is adapted to engaging with said engaging recess.

5. The engaging structure of a loose-leaf storing box as in claim 1, wherein: said engaging rod and said stub of said slipping-in member are extended out of said connecting sheet and are integrally injection formed together with said storing box using plastic.
